(19) United States
(12) Patent Application Publication
(10) Pub. No.: US 2016/0313876 A1
(43) Pub. Date: Oct. 27, 2016

(54) PROVIDING USER-INTERACTIVE GRAPHICAL TIMELINES

(71) Applicant: Google Inc., Mountain View, CA (US)

(72) Inventors: Xin Dong, Palo Alto, CA (US); Christopher Tim Althoff, Stanford, CA (US); Kevin Patrick Murphy, Palo Alto, CA (US); Safa Alai, Mountain View, CA (US); Van Dang, Sunnyvale, CA (US); Wei Zhang, Redwood City, CA (US)

(21) Appl. No.: 15/136,657

(22) Filed: Apr. 22, 2016

Related U.S. Application Data
(60) Provisional application No. 62/151,211, filed on Apr. 22, 2015.

(51) Int. Cl. G06F 3/0482; G06F 17/30; G06T 11/20; G06F 3/0484; G06F 3/0481

(52) U.S. Cl. CPC G06F 3/0482; G06F 3/04842; G06F 3/04845; G06F 3/04817; G06T 11/206; G06F 17/30029; G06F 2203/04806

(57) ABSTRACT

Methods, systems, and apparatus, including computer programs encoded on computer storage media, for combining authentication and application shortcut. An example method includes responsive to a user request identifying an entity: identifying a first time period associated with the entity based at least on a type of the entity; determining, within the first time period, a plurality of first candidate entities associated with the first entity; selecting first entities in the plurality of first candidate entities according to one or more selection criteria; and providing, for presentation to the user, first user-selectable graphical elements on a first graphical user-interactive timeline. Each first user-selectable graphical element identifies a corresponding first entity in the first entities.

### CROSS-REFERENCE TO RELATED APPLICATIONS

This application claims the benefit under 35 U.S.C. §119(e) of the filing date of U.S. Patent Application No. 62/151,211, for Providing User-Interactive Graphical Timelines, which was filed on Apr. 22, 2015, and which is incorporated here by reference.

### BACKGROUND

This specification relates to providing user-interactive graphical timelines.

Conventional techniques for presenting several related information segments at once can help a user appreciate relationships, e.g., the relatedness, between these information segments. These conventional techniques, however, sometimes require special user efforts to reveal the data relationships between information segments.

### SUMMARY

In general, this specification describes techniques for providing user-interactive graphical timelines.

In general, one innovative aspect of the subject matter described in this specification can be embodied in methods that include the actions of: responsive to a user request identifying an entity: identifying a first time period associated with the entity based at least on a type of the entity; determining, within the first time period, a plurality of first candidate entities associated with the first entity; selecting first entities in the plurality of first candidate entities according to one or more selection criteria; and providing, for presentation to the user, first user-selectable graphical elements on a first graphical user-interactive timeline. Each first user-selectable graphical element identifies a corresponding first entity in the first entities.

Other embodiments of this aspect include corresponding computing systems, apparatus, and computer programs recorded on one or more computing storage devices, each configured to perform the actions of the methods. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

The foregoing and other embodiments can each optionally include one or more of the following features, alone or in combination. In particular, one embodiment includes all the following features in combination. The method further includes responsive to a zoom request associated with the first graphical user-interactive timeline: identifying a second time period in accordance with the zoom request and the first time period; identifying, within second time period, a plurality of second candidate entities associated with the entity; selecting second entities in the plurality of second candidate entities; and providing, for presentation to a user, a plurality of second user-selectable graphical elements on a second graphical user-interactive timeline, wherein each second user-selectable graphical element identifies a second entity in the second entities. Identifying a second time period in accordance with the zoom request and the first time period includes: responsive to determining that the zoom request is a zoom-in request: selecting a subset of the first time period as the second time period. Identifying a second time period in accordance with the zoom request and the first time period includes: responsive to determining that the zoom request is a zoom-out request: selecting a superset of the first time period as the second time period. Each first user-selectable graphical element includes a thumbnail image identifying the corresponding first entity. The one or more selection criteria include one or more of: a relevance criterion, a temporal diversity criterion, or a content diversity criterion. The method further includes: responsive to a user selection of a first user-selectable graphical element: identifying a first entity identified by the first user-selectable graphical element time; identifying a second time period associated with the first entity; identifying, within the second time period, a plurality of second entities associated with the first entity; and presenting, to a user, a plurality of second user-selectable graphical elements on a second graphical user-interactive timeline, wherein each second user-selectable graphical element identifies a second entity in the plurality of second entities. The determining the plurality of first candidate entities associated with the first entity includes is based on a relationship between the first entity and a plurality of entities and a timestamp associated with each entity of the plurality of entities. Selecting the first entities includes selecting the first entities based at least in part on a height and width of the first graphical user-interactive timeline. The one or more selection criteria include a content diversity criteria, wherein content diversity provides a diverse group of first entities including selecting entities of different types from among the first candidate entities. The one or more selection criteria include a content diversity criteria, wherein content diversity provides a diverse group of first entities such that the selection is based on a width and height of a graphical element representing an entity presenting on the timeline and a total number of graphical elements that may be stacked on each other when presented on the timeline. The one or more selection criteria include a temporal diversity criterion, wherein the temporal diversity criterion specifies that graphic elements representing a number of the selected first entities fit into the timeline having a specified width and height without overlap.

Particular embodiments of the subject matter described in this specification can be implemented so as to realize one or more of the following advantages. Data mining can be made easier: relationships between entities that may not be readily appreciable can be automatically identified and visually illustrated to a user. User efforts required for interacting with a timeline can also be reduced: timelines can be modified and new ones generated responsive to user interactions by reusing information gathered while generating previous timelines.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example system for providing a user-interactive graphical timeline.

FIG. 2 is a flow diagram illustrating an example process for identifying candidate entities for a user-specified entity.

FIG. 3 is a block diagram illustrating an example presentation of entities on a user-interactive graphical timeline.

FIG. 4 is a block diagram illustrating an example updated presentation of entities on a user-interactive graphical timeline responsive to a user interaction.

FIG. 5 is a block diagram illustrating an example process for providing a user-interactive graphical timeline.

Like reference numbers and designations in the various drawings indicate like elements.

### DETAILED DESCRIPTION

A timeline provides a way of displaying, between two different points in time, a set of entities in a chronological order.

The technologies described in this specification provide various technical solutions to provide graphical user-interactive timelines based on a user-specified entity. These technologies can not only help users understand the order or chronology of related events and estimate future trends, but also help users visualize time lapses between events as well as durations, simultaneity, or overlap of events.

For example, when a user is looking for information about a particular actor, e.g., “Robert Downey Jr.,” a system implementing technologies described in this specification can identify entities that relate to the actor Robert Downey Jr., e.g., his father Robert Downey Sr., movies Robert Downey Jr. has stared in, and other actors with whom Robert Downey Jr. has worked.

The system may filter out entities that it classifies as not sufficiently relevant or diverse. For example, if ten actors identified by the system co-starred the same movie with Robert Downey Jr, the system may select only three of these actors for example, to present on a timeline. This can allow the system to make room on the timeline for presenting other entities, e.g., Robert Downey Jr.'s family members or movies that he has starred.

After filtering out certain entities, the system can present a timeline that includes thumbnail images identifying the selected entities. The system can modify the timeline responsive to a user interaction, e.g., showing only a sub-portion of the timeline with different entities that are particularly relevant to that sub-portion.

In these ways, relationships among entities that are not otherwise readily identifiable may be analyzed and illustrated without requiring special user effort.

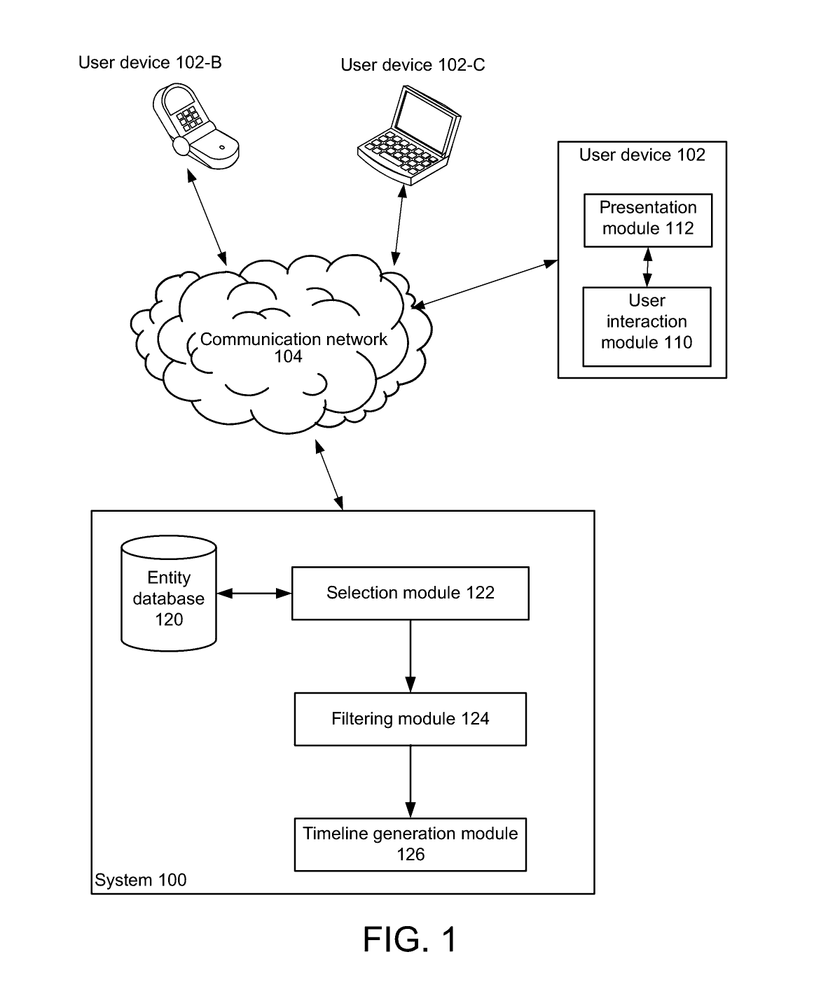

FIG. 1 is a block diagram of an example computing system 100 that implements graphical timeline technologies described in this specification. The system 100 is communicatively coupled with one or more user devices 102 through a communication network 104. The system 100 includes one or more computers at one or more locations, each of which has one or more processors and memory for storing instructions executable by the one or more processors.

A user device 102 presents to a user a graphical user-interactive timeline and detects user interactions with, e.g., zooming-in and zooming-out on, the timeline. A user device 102 may also communicate these user interactions to the system 100. A user device may be, for example, a desktop computer or a mobile device, e.g., a laptop 102-C, a smartphone 102-B, or a tablet computer.

A user device 102 includes a user interaction module 110 and a presentation module 112. The user interaction module 110 detects user interactions with, e.g., gesture, mouse, or keyboard inputs to, the user device 112 and provides them to the system 100. The presentation module 110 provides a graphical user interface (GUI) for presenting and modifying a timeline on a display device of the user device 102, e.g., a smartphone's touchscreen, responsive to a user input.

The communication network 104 enables communications between a user device 102 and the system 100. The communication network 104 generally includes a local area network (LAN) or a wide area network (WAN), e.g., the Internet, and may include both.

The system 100 receives, from a user device 102, user requests and provides, to the user device 102, data used to present timelines responsive to the user requests. The system 100 includes an entity database 120, a selection module 122, a filtering module 124, and a timeline generation module 126.

The entity database 120 stores information identifying one or more entities, e.g., dates of birth of people, release dates of movies, business addresses of companies, as well as dates and places of occurrence of predefined events.

The selection module 122 identifies candidate entities relating to a user-specified entity, e.g., movies having the same type, as well as relatives, friends, and coworkers of a person. For example, the selection module 122 can process data, including data from the entity database 120, using one or more computers to identify the candidate entities relating to the user-specified entity.

The filtering module 124 filters out one or more candidate entities from those identified by the selection module 122 based on predefined selection criteria. For example, the filtering module 124 can use one or more computers to analyze the candidate entities based on the selection criteria to filter out one or more of the candidate entities. The entities remaining after the filtering can be represented on a timeline generated for presentation on a corresponding user device.

The timeline generating module 126 generates a timeline configured to present information, e.g., images and texts, identifying entities selected by the filtering module 124 when presented on a user device, e.g., user device 102. In particular, the timeline generating module 126 generates the timeline for presentation in a graphical user interface of the user device.

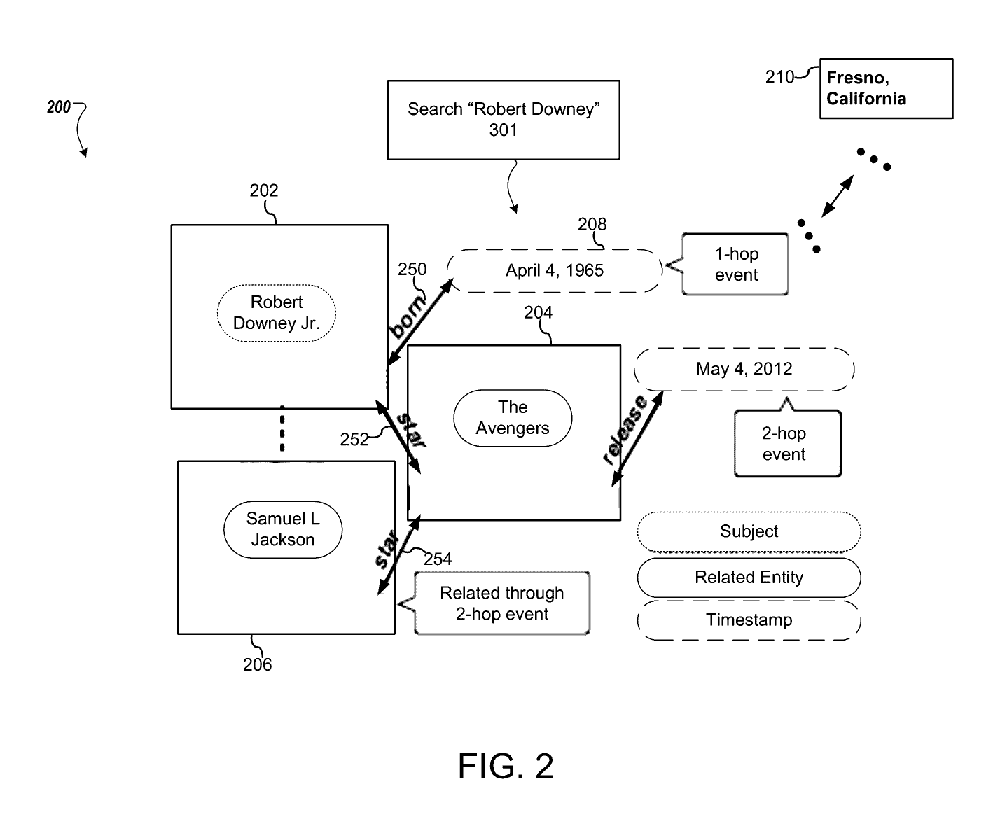

FIG. 2 is a block diagram illustrating an example process 200 for identifying candidate entities for a user-specified entity. For convenience, the process 200 will be described as being performed by a system, e.g., the selection module 122 of the system 100 shown in FIG. 1, of one or more computers, located in one or more locations, and programmed appropriately in accordance with this specification.

The system identifies, from an entity database, an entity specified by a user, which is also referred to as a user-specified entity in this specification.

For example, when a user provides a search query having one or more search terms, the system may identify an entity based on the search terms. Similarly, when a user provides a visual search query including an image, the system may identify an entity based on the image or its metadata or both. Furthermore, in another example, when a user provides an audio search query including audio data, the system may identify an entity based on the audio data or their metadata or both.

For example, the system can apply an optical character recognition (OCR) technique or a pixel analysis technique to identify texts within an image included in a visual search query or the system can transcribe audio data included in an audio user search query using a speech to text technique to identify texts represented by the audio data.

In some implementations, the system can then identify the user-specified entity based on these texts using a query matching algorithm, which (1) determines a degree of matching between texts identified from a user search query and entity information, e.g., entity name or entity description, stored in an entity database, and (2) identifies an entity in the entity database as the user-specified entity when the degree of matching is more than a predefined level, e.g., 95%.

For example, as shown in FIG. 2, when a user provides a search query having the search phrase “Robert Downey,” the system may identify, in the entity database, the entity “Robert Downey Jr.” as the user-specified entity.

The system identifies a time period relevant to the user-specified entity. The time period relevant to the user-specified entity may be based on the type of entity. For example, when the user-specified entity represents a person, the system may classify a particular portion of the person's life span as the relevant time period; when the entity represents a non-person entity, e.g., a movie or a building, the system may classify a time period during which particular events about the entity occurred as the relevant time period.

For example, for a movie entity, the relevant time period may include from the first public release of the movie to the most recent of rerun by a prominent TV station. For a building entity, the relevant time period may start with the building construction and end with the building demolition. For an event entity, e.g., a sports game, the relevant time period may include between when the event first took place and when the event finished.

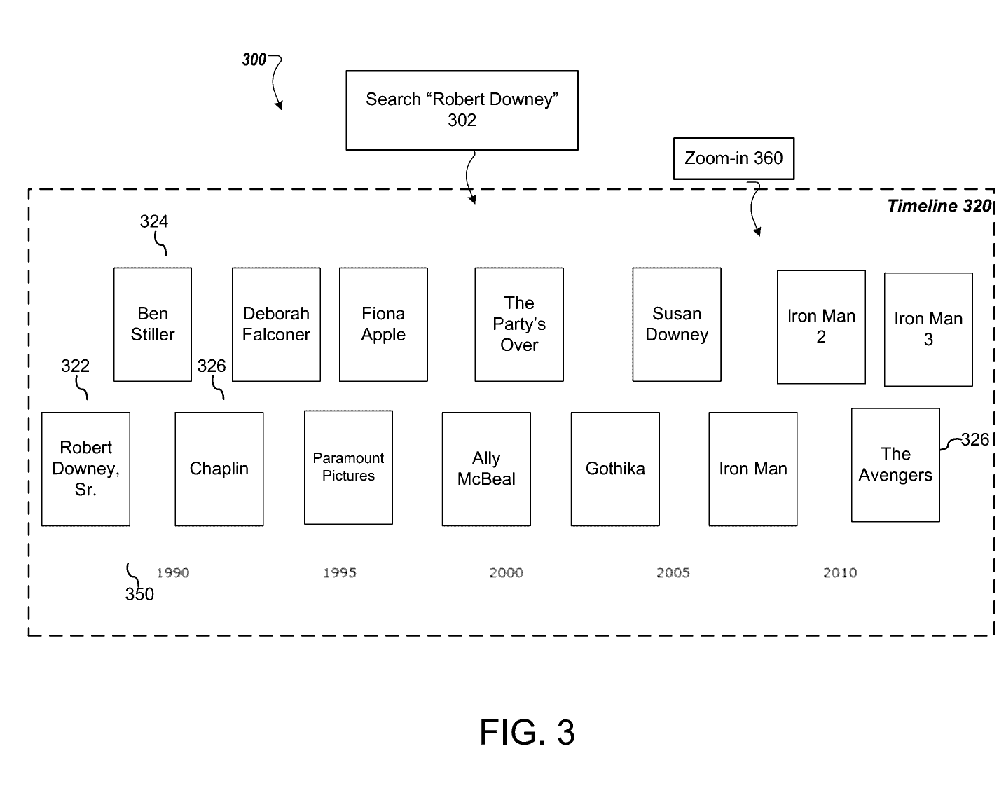

For example, as shown in FIG. 3, the system identifies a time period from 1970 to 2013 as relevant to the entity “Robert Downey Jr.” Because Robert Downey starred his first movie in 1970 and his most recent movie in 2013.

Based on the user-specified entity, the system identifies one or more entities, which are also referred to as candidate entities in this specification. The system identifies candidate entities based on their relationships with the user-specified entity and their respective timestamps. For example, the system may search an entity graph in order to identify the candidate entities.

In some implementation, entity relationships are represented and identified using a graph that includes nodes as well as edges connecting each node to one or more other nodes. A node can represent an entity; an edge connecting two nodes represents a direct relationship between these two nodes.

In some implementations, the system may identify, as candidate entities, entities that are directly related to the user-specified entity. For example, after identifying the entity “Robert Downey Jr.” 202, the system looks for entities that have a same timestamp as the entity 202 and are one level, e.g., hop, of relationship away from it.

The system may classify the entity 204, the movie “The Avengers,” as directly related to entity “Robert Downey Jr.” 202. The system makes this classification based on the relationship, as represented by the edge 252, that Robert Downey Jr. has starred in the movie “The Avengers.”

In some implementation, the system identifies directly related entities using the following expression:

$$s {\to }^{{p}_{1}} {re}_{1} {\to }^{{p}_{2}} t .$$

Here, s represents the user-specified entity; re1 represents a related entity; t represents a timestamp; and p1 and p2 represent predicates that need to be met in order to classify two entities as directly related.

In some implementations, the system may also identify, as candidate entities, entities that are indirectly related to the user-specified entity. For example, after identifying the entity “The Avengers” 204 as a candidate entity, the system further looks for entities that are one level of relationship away from the entity 204—and are thus maybe two levels of relationships away from the user-specified entity 202.

The system may classify the entity “Samuel L. Jackson” 206 as indirectly related to the entity “Robert Downey Jr.” 202. The system makes this classification based on the relationship, as represented by the edge 254, that Samuel L. Jackson has also starred in the movie “The Avengers.”

In some implementation, the system identifies indirectly related entities uses the following expression:

$$\begin{matrix}{s}_{1} {\to }^{{p}_{1}} \\ {s}_{2} {\to }_{{p}_{3}}\end{matrix} {re}_{1} {\to }^{{p}_{2}} t .$$

Here, s1 and s2 represent two different entities; re1 represents an entity that is related to both s1 and s2; t represents a timestamp; and p1, p2, and p3 represent predicates. In these ways, the system can identify entities that are n-level of relationship away from a user-specified entity.

In some implementations, the system may classify two entities as related to each other, when the nodes representing these entities are connected by fewer than a predefined number of edges, e.g., 4 or less. In this way, the system can identify entities that are reasonably related and avoid entities that are only tenuously related.

In some implementations, the system represent entities and their relationships using compound value type (CVT) nodes. A CVT node can represent an n-ary relation; each property in a CVT node can identify an entity specified in the n-ary relation. As defined in this specification, an n-ary relation on sets A₁, . . . , Aₙ is a set of ordered n-tuples <a₁, . . . , aₙ> where aᵢ is an element of Aᵢ for all i, where 1=<i=<n.

For example, the relationship that Robert Downey Jr. starred the “Iron Man” role in “The Avengers” movie may be represented using the following triples:

$$/ m / Robert {\to }^{/ film / actor / film} CVT$$

$$CVT {\to }^{/ film / performance / character} / m / IronMan$$

$$CVT {\to }^{/ film / performance / film} / m / Avengers$$

Two or more CVT nodes can be collapsed to represent a direct relationship, e.g., by

replacing each multi-edge path in the

$$a {\to }^{{p}_{1}} CVT {\to }^{{p}_{2}} b$$

with a single edge

$$a {\to }^{{p}_{1} \cdot {p}_{2}} b .$$

When two directly related entities have different CVT node identifiers, the identifier of a third entity that directly related to both of these two entities may be used to replace the CVT node identifiers of these entities.

For example, the relationship that musician A is part of a band X is represented by a CVT node 1, which identifies the role he played, e.g. a singer or a drummer, the name of the band X, and the date he joined the band X. But the relationship that musician B is also part of the band X may be represented by a CVT node 2, which has a different identifier from that of the CVT node 1.

In some implementation, the system may replace the identifier of the CVT node 1 and that of the CVT node 2 with a same CVT node identifier, the identifier of the CVT node 3 representing the band X. In some implementations, the system selects an identifier for replacing existing CVT identifiers of directly related entities using the following formula:

$${p}_{2}^{*} ( {p}_{1} ) = {arg min}_{{p}_{2}} {max}_{b} \vert \{ b \vert ∃ a , CVT \text{:} e = a {\to }^{{p}_{1}} CVT {\to }^{{p}_{2}} b \} \vert$$

Here, a and b represent different entities; p1 represents an incoming predicate; and p2 represents an outgoing predicate.

The system identifies a relevant time period based on the user-specified entity. For example, if the user-specified entity represents a person, the system may classify a particular portion of the person's life span as the relevant time period; if the entity represents a non-person entity, e.g., a movie or a building, the system may classify a time period during which particular events about the entity occurred as the relevant time period. For example, for an entity that represents a movie, the relevant time period may include from the first public release of the movie to the most recent of rerun by a prominent TV station; for an entity that represents a building, the relevant time period may start with the building construction and end with the building demolition.

Using these techniques, the system can identify candidate entities that relate to the user-specified entity and the identified time period. The system may classify a candidate entity as relevant to a time period, if the candidate entity is associated with a timestamp that identifies a time within the identified time period. For example, the entity “Chaplin” relates to the user-specified entity “Robert Downey Jr.” and the time period 1990-2010, because Robert Downey Jr. starred the movie Chaplin in 1992.

After identifying a predefined number of candidate entities, the system selectively provides entities within the candidate entities for presentation on a graphical timeline.

In some implementations, the system selects entities based on one or more of the following selection criteria: relevance, temporal diversity, and content diversity.

The relevance criterion specifies that a candidate entity having a specified degree of relevance to the user-specified or another candidate entity may be selected. In some implementations, two entities are related to each other if they share a particular type of event. For example, the system may classify the entity “Chaplin” as related to the entity “Robert Downey Jr.” due to the “starred in the movie” event, e.g., Robert Downey Jr. starred the movie Chaplin. For example, the system may classify the entity “New York City, N.Y.” as not related to the entity “Fresno, Calif.,” if the only event, as identified in the entity database, shared by these entities is “the same continent,” e.g., the New York City and the City of Fresno are located on the same North America continent.

In some implementations, two entities are related if nodes representing these entities are linked to each other on a graph, e.g., the graph 200, by a path of relationships that is less than a specified length.

For example, the system may classify the entity “The Avengers” as related to the entity “Robert Downey Jr.,” because on the graph 200, nodes representing these entities are linked to each other by a single edge. For another example, the system may classify the entity “The Avengers” as unrelated to the entity “Fresno, Calif.” because nodes representing these entities are linked on the graph 200 by a path including 20 or more edges.

FIG. 3 is a block diagram illustrating an example presentation 300 of entities on a user-interactive graphical timeline 300. For convenience, the process for providing the presentation 300 will be described as being performed by a system, e.g., the system 100 shown in FIG. 1, of one or more computers, located in one or more locations, and programmed appropriately in accordance with this specification.

In response to a received search query 302, the system identifies, in an entity database, a user-specified entity and a time period relevant to the user-specified entity. For example, the system may identify the entity “Robert Downey Jr.,” as matching the search query “Robert Downey” and the time period between 1970 and 2013 as relevant to the entity “Robert Downey Jr.”

Having identified both the user-specified entity and the relevant time period, the system identifies candidate entities, e.g., using techniques described with references to at least FIG. 2.

The system then selects a subset of the candidate entities for presentation on a timeline. This selection process is also referred as a filtering process in this specification. The filtering process helps to ensure that a timeline is content diverse and visually balanced.

As part of the filtering process, in some implementations, the system selects entities based on one or more content diversity criteria. A content diversity criterion specifies that candidate entities that are diverse to each other to a predefined degree may be selected for presentation on a timeline.

In the above example, the system may elect not to present on the timeline 350 a majority of the entities representing actors who have starred a same movie with Robert Downey Jr. Because this presentation may cause a timeline to be focused on a narrow subject matter, content diversity may be lacking. A data representation that lacks content diversity may not only lose user interest, but also omit data relationships, reducing its efficacy.

To achieve content diversity, the system may select entities that are of different types or categories. For example, when selecting a total of six entities for presentation on a timeline, the system may select entities having different types, e.g., three person entities, one car entity, and two movie entities, rather than selecting all six person entities.

These techniques can be advantageous, as a user may be interested in and may benefit from a diverse range of subject matter.

In some implementation, the system applies the following formula to achieve content diversity on a timeline T*:

$${T}^{*} = {arg max}_{T ⊆ E} REL ( s , T )$$

$$s . t . \\ CONSTRAINTS ( T , w , n ) .$$

Here, E represents a set of candidate entities; s represent a user-specified entity; w and n represent the width and the height, respectively, of a graphical element representing an entity presented on a timeline, e.g., the height and width can be a specified number of pixels when rendered in a GUI on a display; and n represents the total number of graphical elements that may be stacked on each other.

Further, the function REL(s; T) represents a quality of the selected subset of entities T with respect to s. This is defined as a convex combination of two different kinds of relevance functions:

REL(s,T)=λEREL(S,T)+(1−λ)DREL(s,T).

Here, 0≦λ≦1 balances the importance of related entities (EREL) with the importance of related dates (DREL). In some implementations, the system sets λ to 0.75.

In addition to content diversity criteria, in some implementations, the system selects entities based on one or more temporal diversity criteria.

In the above example, the system may elect not to present on the timeline 350, which covers from 1970 to 2013, a majority of the entities relevant to only 1995.

Because this presentation may cause entity information to be concentrated on a narrow stretch of a timeline, resulting in visual crowding on that specific portion of the timeline and a visually imbalanced timeline as a whole. A visually imbalanced data representation may obscure data relationships and render user interaction difficult, reducing its efficacy.

In some implementations, the system applies a temporal diversity constraint, which specifies that graphic elements representing entities on a timeline should fit into a timeline of width W and height H without overlap, e.g., the height and width of the timeline can be a specified number of pixels when the timeline is rendered in a GUI on a display. If the graphic elements, e.g., boxes, having widths w depicting two entities temporally overlap, the system can stack them on each other, without overlap, as shown by the way the entity 322 and the entity 324 are presented on the timeline 350.

In some implementations, the system applies the following expression to achieve temporal diversity on a timeline T:

∀t∈R:|Tη[t,t+w)|≦n.

Here, R represents the time interval shown on a timeline; t represents an entity's timestamp; w represents the width of a graphical element, e.g., in pixels; n represents the height allowed when stacking graphical elements.

After selecting one or more entities from the candidate entities, the system presents graphical elements, e.g., thumbnail images or texts, identifying these entities on a graphical user-interactive timeline. Graphical elements can include, for example, an image representing the entity and/or a textual label identifying the entity.

For example, as shown in FIG. 3, for entity 324 “Ben Stiller,” a thumbnail image of Ben Stiller and the text “Ben Stiller” are presented as a single graphic element on the timeline 350.

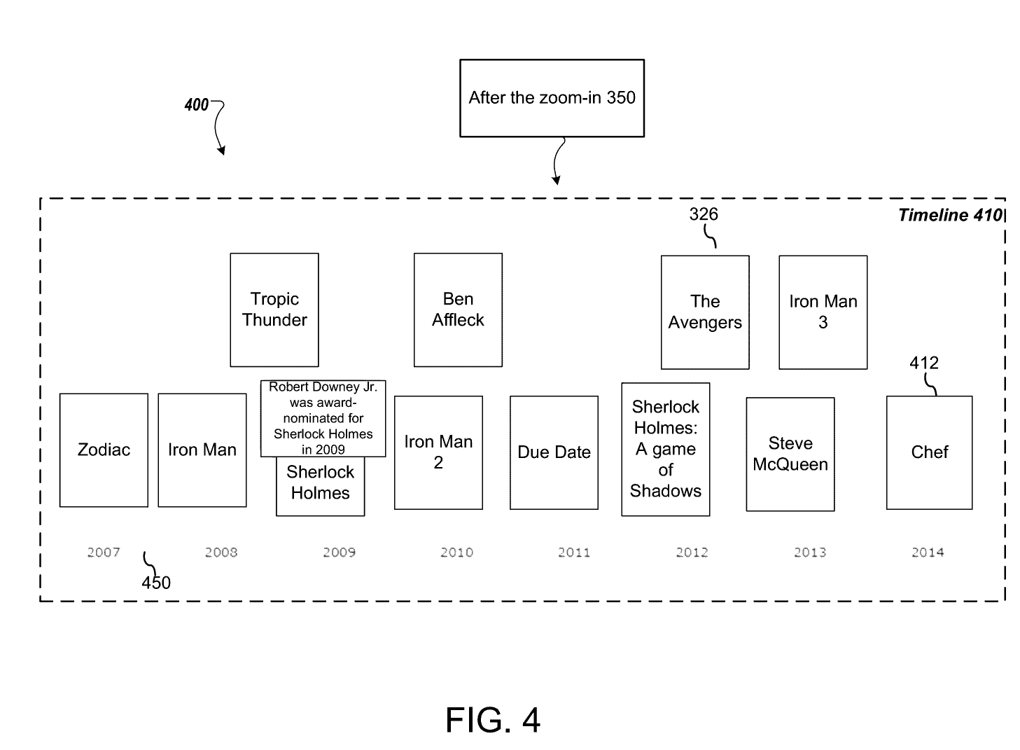

The system can update a timeline responsive to user interaction with the timeline. For example, responsive to a zoom request by a user, the system can update the timeline 350 by presenting an updated timeline 450, which is described with reference to FIG. 4.

FIG. 4 is a block diagram illustrating an example updated presentation 400 of entities on a user-interactive graphical timeline responsive to a user interaction.

For convenience, the process for providing the update presentation 400 will be described as being performed by a system, e.g., the system 100 shown in FIG. 1, of one or more computers, located in one or more locations, and programmed appropriately in accordance with this specification.

After presenting a timeline, the system can modify the timeline according to user interactions with the timeline, e.g., changing the time period represented in the timeline or presenting additional information on the timeline or both.

After detecting a user interaction with a timeline, the system determines several characteristics of the user interaction. The system may determine, for example, (1) with which portion of the timeline a user has interacted, e.g., the portion between 2005 and 2010 or (2) the type of the user interaction, e.g., a selection or mouse-over of a graphical element or a zoom-in or -out on a timeline.

The system next determines how to update the timeline responsive to the detected user interaction.

For example, after detecting that a user has zoomed-in on the portion between the 2005 and 2010 of the timeline 350, the system repeats one or more of the process 300 and presents a new timeline 450 to replace the timeline 350.

When presenting the new timeline 450, the system uses the same matching entity “Robert Downey Jr.,” but selects relevant entities based on a different time period, e.g., between 2005 and 2010. In these ways, the system does not require a user to expressly specify an entity, when interacting with timelines.

As part of presenting the new timeline 450, the system removes the entities 322-326 from presentation and presents a new entity 412. This is because new entity 412 falls within the new time period, e.g., between 2005 and 2010, while removed entities 322-326 do not.

In some implementations, when presenting a new timeline, the system reuses candidate entities that were identified when constructing the previous timeline. For example, the system can re-evaluate candidate entities that were previously identified but not selected by the process 300, when presenting the timeline 450. Reusing past entity identifications or filtering results can enhance system responsiveness, as time required for rerun these steps may be reduced or eliminated.

In other implementations, entities are identified and selected anew in response to user interactions. For example, the system can rerun one or more steps, e.g., the candidate entity identification and entity selection, described in process 300, when presenting the timeline 450. Thus, in response to the user interactions, relevant information not previously available may now be included in the new timeline.

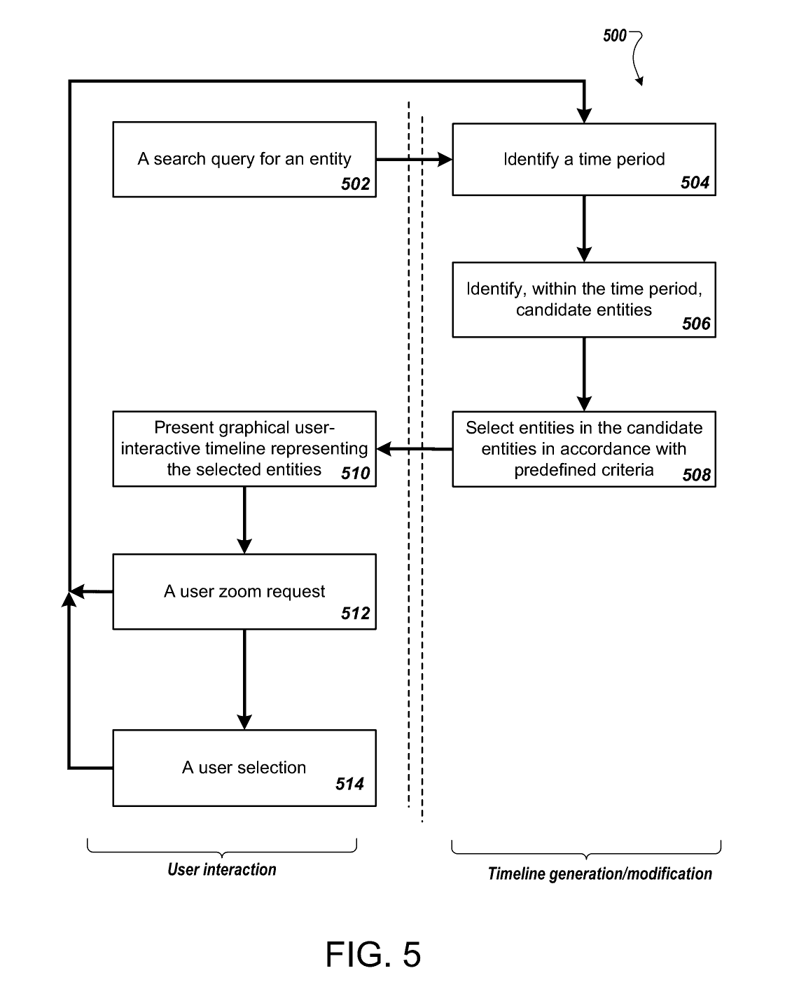

FIG. 5 is a flow diagram illustrating an example process 500 for providing user-interactive graphical timelines. For convenience, the process 500 will be described as being performed by a system, e.g., the system 100 shown in FIG. 1, of one or more computers, located in one or more locations, and programmed appropriately in accordance with this specification.

The process 500 begins with a user device obtaining and transmitting to the system a search query for an entity (step 502).

In response to the search query for the entity, the system identifies, in an entity database such as entity database 120, a user-specified entity based on information provided in the search query, e.g., a portion of text, an image, or audio data. The system next identifies a relevant time period based on the user-specified entity (step 504). The relevant time period can be based at least on a type of the user-specified entity.

Based on the identified time period, the system identifies candidate entities, e.g., using selection module 122, that are classified as relevant to the user-specified entity (step 506). The system then, according to predefined criteria, selects a subset of the candidate entities for presentation on a timeline (step 508), e.g., using filtering module 124.

The system next generates a timeline with graphical elements, e.g., thumbnail images and text describing these images, identifying the entities selected for presentation on the user device (step 510), e.g., using timeline generation module 126.

The user device can present the timeline and detect user interactions, e.g., zoom requests or entity selections, with the timeline.

In some implementations, after detecting a zoom request (step 512), e.g., a mouse scroll over a particular portion of the timeline, the user device transmits information identifying the zoom request, e.g., the relative location of the mouse scroll on the timeline, to the system.

Based on this information, the system can then identify a new timeline. For example, when a user zooms-in on the first half of a timeline that spans from 1980 to 2000, the system may reduce the time interval covered in the timeline to produce a new timeline covering between 1980 and 1990. For another example, when a user zooms-out from a timeline that spans from 1980 to 2000, the system may enlarge the time interval covered in the timeline to produce a new timeline covering between 1970 and 2010.

After identifying the new timeline, the system may rerun one or more of the above described steps, e.g., step 506 and step 508, to identify or select entities for presentation on the new timeline.

In some implementations, after detecting a selection of a graphical element representing an entity (step 514), e.g., a mouse click on a thumbnail image representing the entity, the user device identifies the entity as a new user-specified entity and asks the system to generate a new timeline based on the this new user-specified entity.

After identifying the new user-specified entity, the system may rerun one or more of the above described steps, e.g., step 504, step 506, and step 508, to identify or select entities for presentation on a new timeline.

In this specification, the term “database” is used broadly to refer to any collection of data: the data does not need to be structured in any particular way, or structured at all, and it can be stored on storage devices in one or more locations. Similarly, in this specification the term “module” will be used broadly to refer to a software based system or subsystem that can perform one or more specific functions. Generally, a module will be implemented as one or more software components, installed on one or more computers in one or more locations. In some cases, one or more computers will be dedicated to a particular module; in other cases, multiple modules can be installed and running on the same computer or computers.

All of the operations described in this specification may be implemented in digital electronic circuitry, or in computer software, firmware, or hardware, including the structures disclosed in this specification and their structural equivalents, or in combinations of one or more of them. The techniques disclosed may be implemented as one or more computer program products, i.e., one or more modules of computer program instructions encoded on a computer-readable medium for execution by, or to control the operation of, data processing apparatus. The computer readable-medium may be a machine-readable storage device, a machine-readable storage substrate, a memory device, a composition of matter affecting a machine-readable propagated signal, or a combination of one or more of them. The computer-readable medium may be a non-transitory computer-readable medium. The term “data processing apparatus” encompasses all apparatus, devices, and machines for processing data, including by way of example a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) may be written in any form of programming language, including compiled or interpreted languages, and it may be deployed in any form, including as a standalone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer may be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, the techniques disclosed may be implemented on a computer having a display device, e.g., a CRT (cathode ray tube) or LCD (liquid crystal display) monitor, for displaying information to the user and a keyboard and a pointing device, e.g., a mouse or a trackball, by which the user may provide input to the computer. Other kinds of devices may be used to provide for interaction with a user as well; for example, feedback provided to the user may be any form of sensory feedback, e.g., visual feedback, auditory feedback, or tactile feedback; and input from the user may be received in any form, including acoustic, speech, or tactile input.

Implementations may include a computing system that includes a back end component, e.g., as a data server, or that includes a middleware component, e.g., an application server, or that includes a front end component, e.g., a client computer having a graphical user interface or a Web browser through which a user may interact with an implementation of the techniques disclosed, or any combination of one or more such back end, middleware, or front end components. The components of the system may be interconnected by any form or medium of digital data communication, e.g., a communication network. Examples of communication networks include a local area network (LAN) and a wide area network (WAN), e.g., the Internet.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

Thus, particular implementations have been described. Other implementations are within the scope of the following claims. For example, the actions recited in the claims may be performed in a different order and still achieve desirable results.

What is claimed is:

1. A system comprising:
one or more computers; and
one or more storage units storing instructions that when executed by the one or more computers cause the system to perform operations comprising:
responsive to a user request identifying an entity:
identifying a first time period associated with the entity based at least on a type of the entity;
determining, within the first time period, a plurality of first candidate entities associated with the first entity;
selecting first entities in the plurality of first candidate entities according to one or more selection criteria; and
providing, for presentation to the user, first user-selectable graphical elements on a first graphical user-interactive timeline, wherein each first user-selectable graphical element identifies a corresponding first entity in the first entities.

2. The system of claim 1, the operations further comprising:
responsive to a zoom request associated with the first graphical user-interactive timeline:
identifying a second time period in accordance with the zoom request and the first time period;
identifying, within second time period, a plurality of second candidate entities associated with the entity;
selecting second entities in the plurality of second candidate entities; and
providing, for presentation to a user, a plurality of second user-selectable graphical elements on a second graphical user-interactive timeline, wherein each second user-selectable graphical element identifies a second entity in the second entities.

3. The system of claim 2, wherein identifying a second time period in accordance with the zoom request and the first time period comprises:
responsive to determining that the zoom request is a zoom-in request:
selecting a subset of the first time period as the second time period.

4. The system of claim 2, wherein identifying a second time period in accordance with the zoom request and the first time period comprises:
responsive to determining that the zoom request is a zoom-out request:
selecting a superset of the first time period as the second time period.

5. The system of claim 1, wherein each first user-selectable graphical element includes a thumbnail image identifying the corresponding first entity.

6. The system of claim 1, wherein the one or more selection criteria include one or more of: a relevance criterion, a temporal diversity criterion, or a content diversity criterion.

7. The system of claim 1, the operations further comprising:
responsive to a user selection of a first user-selectable graphical element:
identifying a first entity identified by the first user-selectable graphical element time;
identifying a second time period associated with the first entity;
identifying, within the second time period, a plurality of second entities associated with the first entity; and
providing, for presentation to a user, a plurality of second user-selectable graphical elements on a second graphical user-interactive timeline, wherein each second user-selectable graphical element identifies a second entity in the plurality of second entities.

8. The system of claim 1, wherein a first entity in the first entities identifies an event or a person.

9. The system of claim 1, wherein the determining the plurality of first candidate entities associated with the first entity includes is based on a relationship between the first entity and a plurality of entities and a timestamp associated with each entity of the plurality of entities.

10. The system of claim 1, wherein selecting the first entities includes selecting the first entities based at least in part on a height and width of the first graphical user-interactive timeline.

11. The system of claim 1, wherein the one or more selection criteria include a content diversity criteria, wherein content diversity provides a diverse group of first entities including selecting entities of different types from among the first candidate entities.

12. The system of claim 1, wherein the one or more selection criteria include a content diversity criteria, wherein content diversity provides a diverse group of first entities such that the selection is based on a width and height of a graphical element representing an entity presenting on the timeline and a total number of graphical elements that may be stacked on each other when presented on the timeline.

13. The system of claim 1, wherein the one or more selection criteria include a temporal diversity criterion, wherein the temporal diversity criterion specifies that graphic elements representing a number of the selected first entities fit into the timeline having a specified width and height without overlap.

14. A method comprising:
responsive to a user request identifying an entity:
identifying a first time period associated with the entity based at least on a type of the entity;
determining, within the first time period, a plurality of first candidate entities associated with the first entity;
selecting first entities in the plurality of first candidate entities according to one or more selection criteria; and
providing, for presentation to the user, first user-selectable graphical elements on a first graphical user-interactive timeline, wherein each first user-selectable graphical element identifies a corresponding first entity in the first entities.

15. The method of claim 9, further comprising:
responsive to a zoom request associated with the first graphical user-interactive timeline:
identifying a second time period in accordance with the zoom request and the first time period;
identifying, within second time period, a plurality of second candidate entities associated with the entity;
selecting second entities in the plurality of second candidate entities; and
providing, for presentation to a user, a plurality of second user-selectable graphical elements on a second graphical user-interactive timeline, wherein each second user-selectable graphical element identifies a second entity in the second entities.

16. The method of claim 10, wherein identifying a second time period in accordance with the zoom request and the first time period comprises:
responsive to determining that the zoom request is a zoom-in request:
selecting a subset of the first time period as the second time period.

17. The method of claim 10, wherein identifying a second time period in accordance with the zoom request and the first time period comprises:
responsive to determining that the zoom request is a zoom-out request:
selecting a superset of the first time period as the second time period.

18. The method of claim 9, wherein each first user-selectable graphical element includes a thumbnail image identifying the corresponding first entity.

19. The method of claim 9, wherein the one or more selection criteria include one or more of: a relevance criterion, a temporal diversity criterion, or a content diversity criterion.

20. The method of claim 9, further comprising:
responsive to a user selection of a first user-selectable graphical element:
identifying a first entity identified by the first user-selectable graphical element time;
identifying a second time period associated with the first entity;
identifying, within the second time period, a plurality of second entities associated with the first entity; and
presenting, to a user, a plurality of second user-selectable graphical elements on a second graphical user-interactive timeline, wherein each second user-selectable graphical element identifies a second entity in the plurality of second entities.

21. A non-transitory computer storage medium encoded with a computer program, the computer program comprising instructions that when executed by a computing system cause the computing system to perform operations comprising:
responsive to a user request identifying an entity:
identifying a first time period associated with the entity based at least on a type of the entity;
determining, within the first time period, a plurality of first candidate entities associated with the first entity;
selecting first entities in the plurality of first candidate entities according to one or more selection criteria; and
providing, for presentation to the user, first user-selectable graphical elements on a first graphical user-interactive timeline, wherein each first user-selectable graphical element identifies a corresponding first entity in the first entities.
